(19) United States
(12) Patent Application Publication
(10) Pub. No.: US 2016/0076992 A1
(43) Pub. Date: Mar. 17, 2016

(54) Robotically assisted flexible test and inspection system

(71) Applicant: ASTRONICS TEST SYSTEMS INC., IRVINE, CA (US)

(72) Inventors: Jess Mathew Gillespie, Signal Hill, CA (US); Steven B. Richards, Winter Park, FL (US); Gilberto Oseguera, Corona, CA (US); Robert Chudzinski, Foothill Ranch, CA (US); David Johnston, Rancho Santa Margarita, CA (US)

(21) Appl. No.: 14/756,521

(22) Filed: Sep. 14, 2015

Related U.S. Application Data
(60) Provisional application No. 62/050,192, filed on Sep. 14, 2014.

(51) Int. Cl. G01N 21/01; B25J 9/16

(52) U.S. Cl. CPC G01N 21/01; B25J 9/1697; B25J 9/1674; Y10S 901/47; Y10S 901/02

(57) ABSTRACT

A robotically assisted flexible test and inspection system that is portable and adaptable to test and/or inspect products is described. The test and inspection system is a compact system that can be moved easily to different locations and includes a robotic arm which is used for testing and inspection of a unit-under-test (UUT). The robotic arm can be used to activate different controls in the UUT or cause different functionality of the UUT to be tested. The robotic arm can use different tools such as a switch activator tool, to accomplish its tasks. The test and inspection system in one embodiment is a movable test cart, wherein the robotic arm is located in one of the shelves of the test rack and the UUT is located in another shelf of the test rack which has an aperture that presents portions of the UUT to the robotic arm. Another shelf or shelves of the moveable test rack can accommodate a test system controller, testing and inspection components/instruments, etc.

### CROSS-REFERENCE TO RELATED APPLICATIONS

This application claims the priority benefit of U.S. Provisional Application Ser. No. 65/050,192, filed Sep. 14, 2014, which is incorporated herein by reference in its entirety.

### FIELD OF THE INVENTION

This invention relates in general to test and inspection systems and more specifically to a robotically assisted flexible test and inspection system.

### BACKGROUND

Test and inspection systems are used in manufacturing operations in order to test and/or inspect products that have been manufactured in order determine if the manufactured product is working to the product's design specifications. Most test and inspection systems tend to be designed for a particular product that will be tested/inspected, making them good for the particular test application they have been designed for, but inflexible when it comes to testing the same product if it has been modified or testing/inspecting other products or multiple products. Another problem with current testing and inspection system, especially those used to test industrial products such as aircraft products (e.g., systems, subassemblies, parts, etc.) is that the test/inspection systems tend to be large fixed systems that are located in a particular location, requiring the products that are to be tested and/or inspected to be brought to the test/inspection system in order for the testing to be performed. This presents issues for manufactures that want flexibility in their manufacturing operations.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a drawing of a portable robotically assisted test and inspection system in accordance with an embodiment of the invention.

FIG. 2 shows a picture of a top side view of a portable robotically assisted test and inspection system in accordance with an embodiment of the invention.

FIG. 3 shows a picture of a side view of a portable robotically assisted test and inspection system in accordance with an embodiment of the invention.

FIG. 4 shows a picture of a robotic arm in accordance with an embodiment of the invention.

FIG. 5 shows another picture of a robotic arm in accordance with an embodiment of the invention.

FIG. 6 shows a side view of a portable robotically assisted test and inspection system in accordance with an embodiment of the invention.

FIG. 7 shows another side view of a portable robotically assisted test and inspection system in accordance with an embodiment of the invention.

FIG. 8 shows a block diagram of a portable robotically assisted test and inspection system in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures.

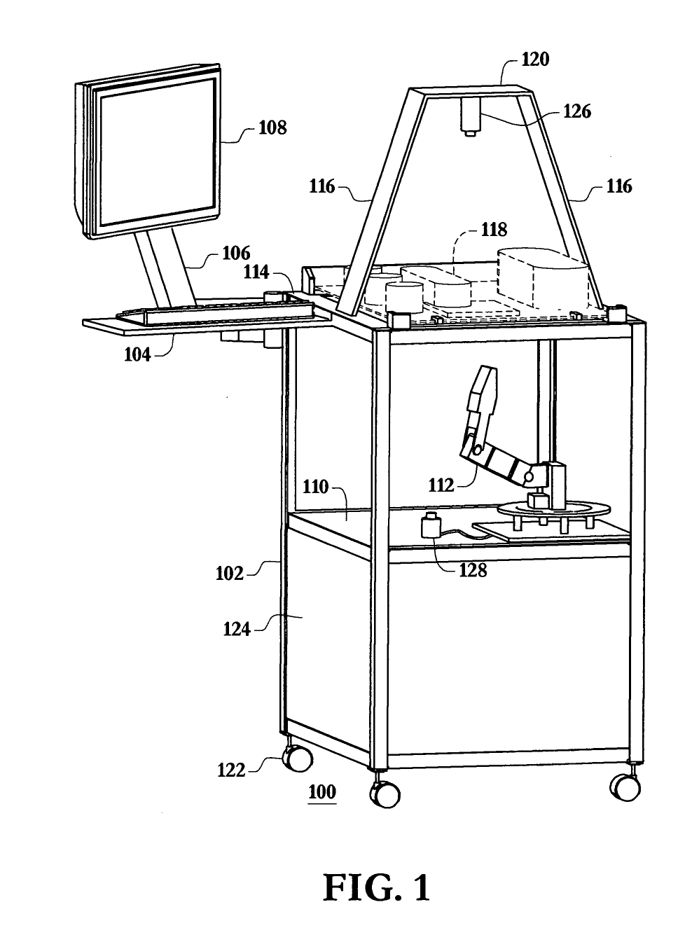

Referring to FIG. 1, there is shown a drawing of a portable test and inspection system 100 in accordance with an embodiment of the invention. Test and inspection system 100 includes a portable test cart 102 having a set of wheels 122 for portability and movability. The test cart 102 includes a support member 104 used in holding a keyboard, mouse, scanner, etc. that is used by the test operator to control and monitor the testing process. A monitor support arm 106 is coupled to the support member 104 and supports a monitor 108 such as an LED or LCD monitor that can provide visual and/or touch screen interface capability for the test operator that is using the test and inspection system 100. Monitor 108 allows the test operator to select to re-run any sub-tests within a particular test sequence.

Although not shown in FIG. 1, a test system controller such as a computer is coupled to the monitor 108 and is used to control the functionality of the test and inspection system 100. In one embodiment the computer is located in the bottom shelf 124 of the portable test cart 102 along with a power supply to provide power to the product being tested, switching and/or testing equipment and/or instruments (not shown) that can also be under the control of the computer and used for conducting tests of the product being tested. Depending on the particular design requirements, portable test cart 102 can have any number of shelves to accommodate different testing/inspection requirements. The computer (not shown) can be a personal computer or specialized test system controller such as a card based computer mounted onto a test rack slot with other electronic boards such as switching/testing boards being mounted on other slots of the test rack.

Portable test cart 102 includes a top shelf 114 which is used to receive a product to be tested. The product to be tested which will be referred to as a unit-under-test (UUT) 118 can be anything from a single component, electronic board, sub-assembly, etc. In one embodiment, the UUT 118 comprises an Astronics PECO division aircraft Passenger Service Unit (PSU) which is an aircraft assembly that is typically located overhead above airline passenger seats in an aircraft and that includes the passenger reading lights, air vents, flight attendant call buttons, emergency oxygen mask door, etc.

A computer controlled robotic arm 112, such as one manufactured by Energid Technologies/Robai is located on a shelf 110 underneath of the top shelf 114. Robotic arm 112 is capable of grasping numerous tools such as a button press tool in order to activate controls such as switches found on the UUT 118. Besides switches/controls found on the UUT 118, the robotic arm can close an emergency oxygen mask door when it is opened during testing, it can also toggle a switch which sends the attendant light to the front or back of the airplane. The robotic arm 112 is strong enough to pick up and use different types of tools for testing of different UUTs.

The top shelf 114 tray has one or more apertures (openings) to allow for certain parts of the UUT 118 to be accessible to the robotic arm 112 which is located underneath the top shelf 114. In one embodiment, there is a singular large opening that allows access to the majority of the UUT 118 to the robotic arm except for a small amount of the edge margin of the UUT which is required to support the UUT to the top shelf 114. The top shelf 114 can include one or more blocks or retention members to fix and register the UUT 118 to a specific location on the top shelf 114. One or more clamps or other type of fixating devices can also be included on the top shelf 114 in order for the UUT 118 to be securely fastened in place prior to the robotic arm 112 activating the controls found on the UUT 118 during the testing sequence. In one embodiment, the robotic arm 112 is under control of the test system controller and has been programmed to test the different controls such as the light switches (buttons) located on the UUT 118. Since the UUT 118 is firmly fixed in place using clamps or other fastening techniques, the robot arm 112 uses predetermined movements and positional alignments under the control of software executed by the test system controller to activate these switches on the UUT 118.

Robotic test and inspection system 100 reduces the time for a human to inspect and test an electro-mechanical device such as UUT 118, collecting the data, analyzing the data through statistical process control (SPC) techniques, developing traceability data, and archiving the data by generating quality inspection reports for a variety of consumer or industrial products, like the aircraft PSU mentioned above. The pass/fail data for the UUTs 118 that have been tested using test system 100 is compared to customer defined limits and the software can document and alert the test operator when results are outside of expected limits. The test operator alerts can comprise audio and/or visual alerts. This helps the test operator make an early detection of a production lot that is potentially defective before more are manufactured and/or tested. Since test system 100 is computer controlled and robotically assisted, it can determine if a UUT 118 has been built and operates to the manufacturers predetermined set of requirements. Test system 100 replaces human vision inspection, audio testing, and touch of buttons with a humanoid manipulator (robotic arm) 112 and computer hardware and software to perform the same tasks as a human tester with higher reliability, all in a small and portable form factor.

Test system 100 also automates the image (e.g., photographic/video) capture of the UUT 118 to validate that the test/inspection was performed, and stores the information in a database along with the part number and serial number information to meet regulatory agency requirements such as the Federal Aviation Administration (FAA) for the collection and archiving of quality inspection reports. The serial number and/or part number of the UUT 118 can be scanned using a scanner or using digital camera 126 or camera 128, depending on the particular design objectives of test system 100. The database can be a local or remote database depending on the particular design requirements for the test system.

Image capture in test system 100 is performed by a machine vision camera 128 located on shelf 110 which is used to take an images (pictures) of the UUT 118 on the side facing the robotic arm 118. The picture(s) taken by camera 128 can be compared using vision compare software run by the computer to a UUT that has been properly manufactured. The vision compare software can detect if any switches, parts, etc. are missing. In one embodiment, the picture or pictures taken by the machine vision camera 128 are stored in a folder with a Log.csv file and is given a unique name (UUTID_YYYYDDMMHHmm.png). The file name is then saved to the database so that when loaded in Excel (and format the row as a link) the picture can be opened in one click.

In test system 100 a second camera 126 is mounted onto support member 120 which is connected to support members 116 which are coupled to the test cart 102. The second or top camera 126 takes a picture and sends it to the vision software found in the test system controller, which inspects the placement and existence of critical components such as screws, wires, lanyards, doors, etc. which make part of UUT 118. Using both cameras 126 and 128 allows for the vision software to inspect both sides of the UUT 118 for any flaws, missing parts and the like. The cameras 126 and 128 and accompanying software can also perform edge detection, color comparison, objection comparison, scan barcodes, determine illumination strength of lights that are activated, etc.

Although in the preferred embodiment, test system 100 is used to test an aircraft PSU, the test system 100 can be configured to test a wide variety of consumer or industrial electronic or electro-mechanical products. The top test shelf 114 can also be designed so that it is easily removable from the test cart 102 and replaced with another top test shelf that can accommodate a different UUT having different dimensions, etc. The new top test shelf can have different aperture(s) (openings) to allow different parts of the UUT to be accessible to the robotic arm 112. The top shelf 114 can be designed to be easily removed using fast disconnect fasteners as known in the art, top support members 116 can be designed to connect to the sides of the test cart 102 so that they are not in the way when the top shelf needs to be replace to accommodate a different UUT.

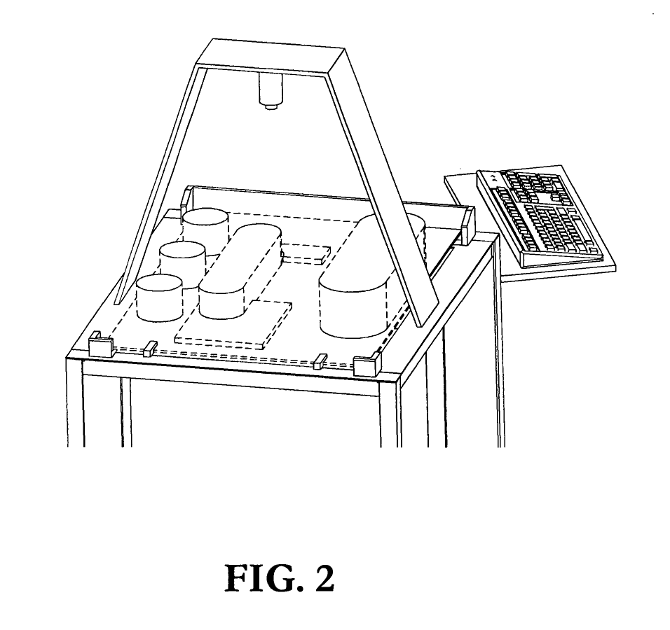

Referring now to FIG. 2, there is shown a top side view of the test system 100. As shown, a digital camera (camera 126 shown in FIG. 1) is located on the top bracket and is used to take images of one side of the UUT (UUT 118 shown in FIG. 1). In this case, the camera 126 takes images of the back side of the UUT 118, in order to verify the components are all there. As shown, the UUT 118 is placed in proper position by a series of support/registration members which hold and align the edges of UUT 118. At the bottom of the picture are locking mechanisms that keeps the UUT 118 firmly positioned in place so that when the robotic arm 112 is actuating the switches, the UUT 118 does not move out of place.

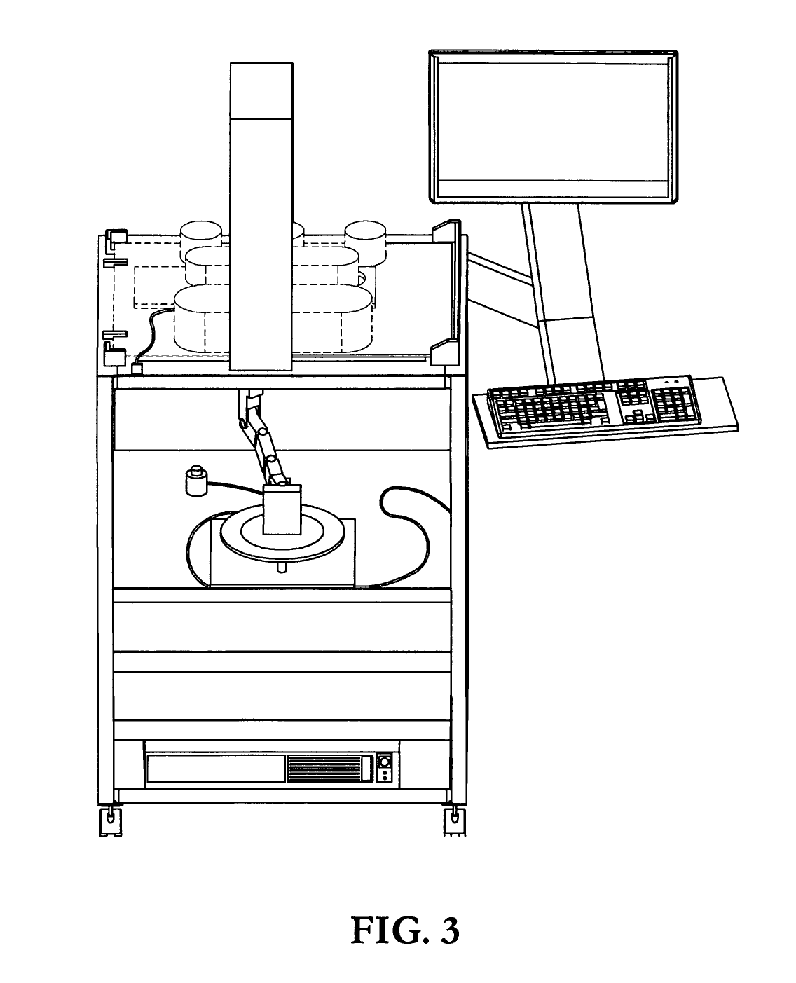

Shown in FIG. 3 is a side view of the portable test system, showing several shelves, one holding the robotic arm, the other two supporting the test system controller (computer) and any necessary switching and test equipment needed to test and inspect the UUT Also shown in this view is a cable connected to the UUT on the lower left corner that is connected to a power supply, power converter, and any test/switching equipment which are used to test the UUT 118. The switching equipment includes a switch card that allows the test system 100 to control power to different components of the UUT individually and use both AC and DC power.

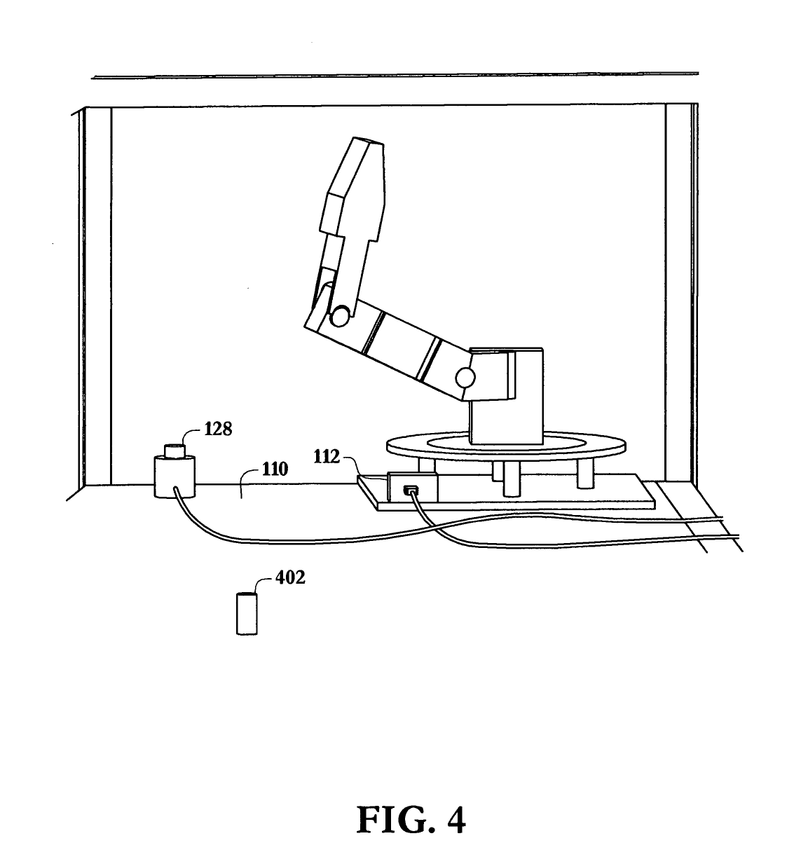

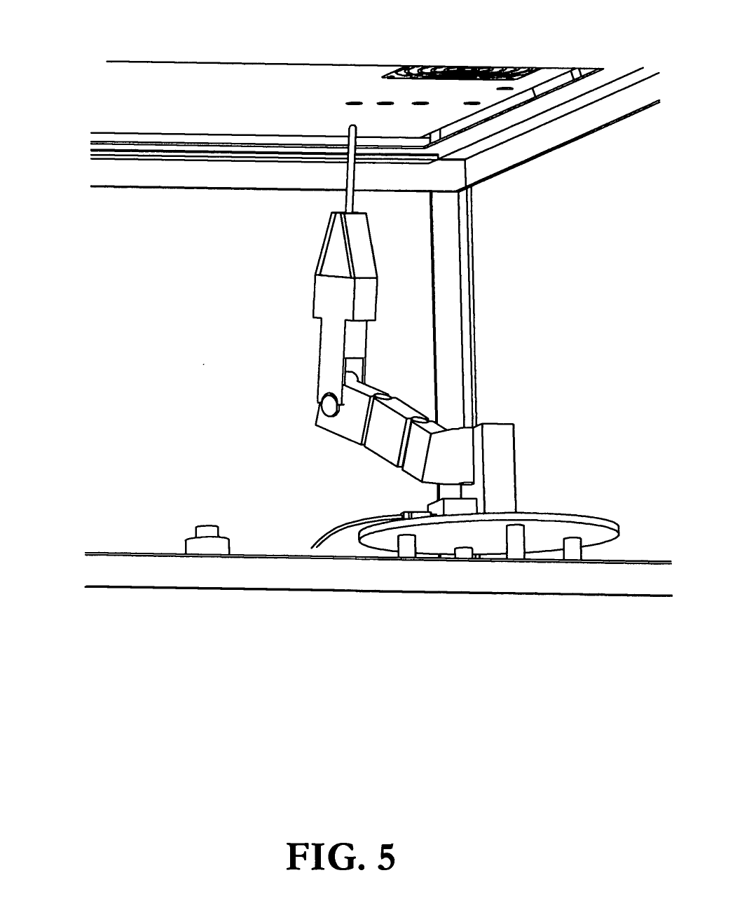

Referring to FIG. 4, there is shown a close up view of the robotic arm 112 which is located on shelf 110. The vision camera 128 is also shown on shelf 110. In this view a microphone 402 is shown which can be used to verify that any audio signals that the UUT 118 needs to produce are in fact produced during testing. Besides a microphone 402, other equipment such as a light detector could also be added in order to check for any light emissions for other UUTs, temperature sensors, etc. can also be included if the UUT requires other types of performance tests. The camera 128 rests on shelf 110 and is used to take images of the side of the UUT which the robotic arm 112 is interacting with. In FIG. 5 there is shown a close up view of the robotic arm 112 using the switch activation tool to activate (press) a light switch found in the UUT 118. In FIG. 5 there is also shown the opening in top shelf 114 which allows a good portion of the UUT 118 to be accessible to robotic arm 112. The robotic arm is shown grasping a switch testing tool used for activating the switches found in the UUT.

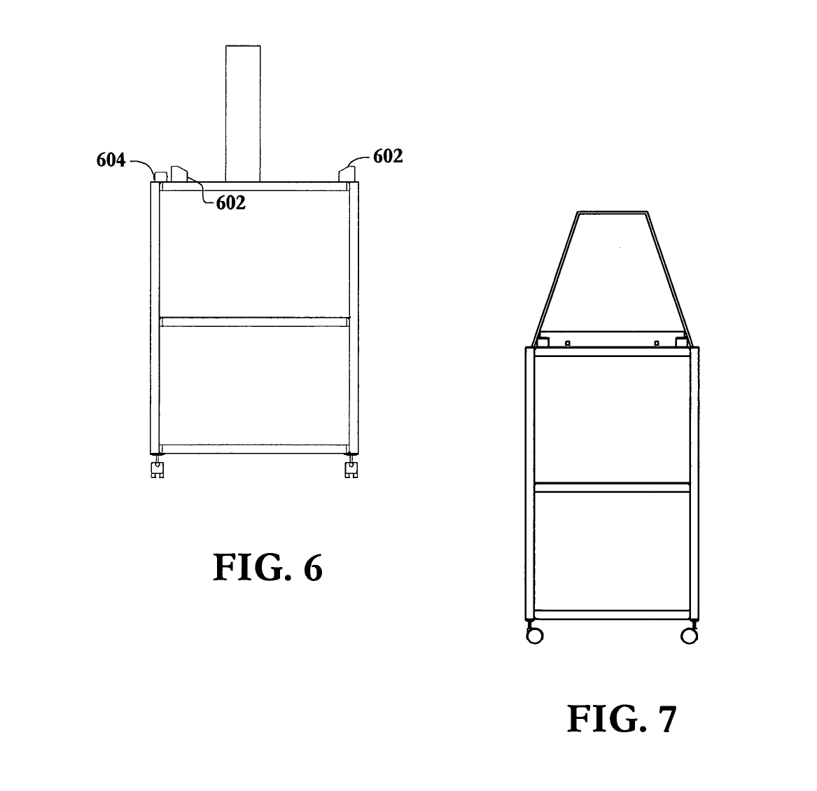

In FIGS. 6 and FIG. 7 there are shown side view drawings of the test system 100. In FIG. 6 there is shown a few of the support members 602 that are used to hold and register the UUT in proper position for testing. One of the lock down clamps 604 which is used to hold down the UUT for testing is also shown.

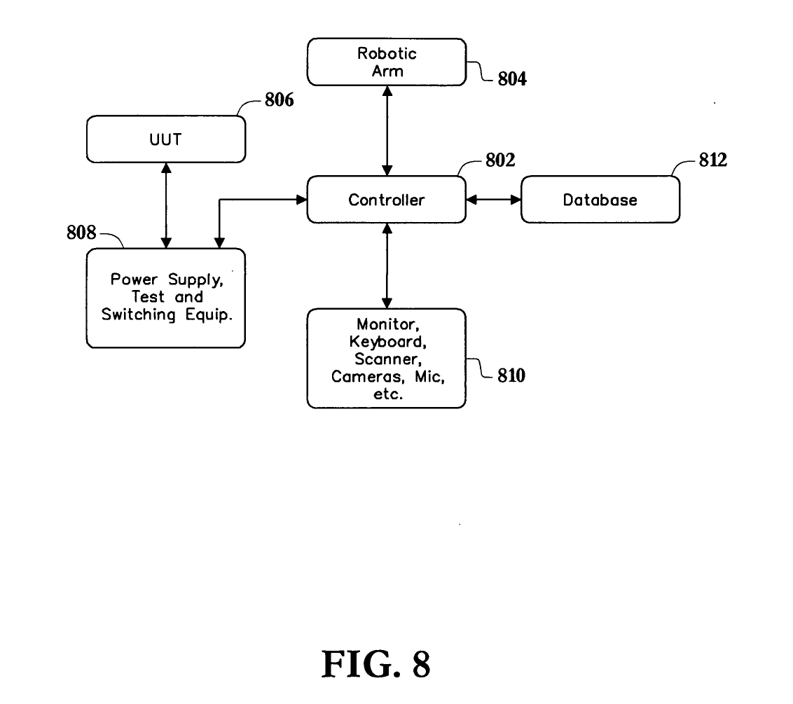

Referring now to FIG. 8, a simplified block diagram of the test system 100 is shown in accordance with an embodiment of the invention. A controller 802 as previously mentioned which can take the form of a personal computer, test controller, or other known in the art control unit can be used to control and execute the software needed to run the test and inspection system 100. Controller 802 executes the robotic arm and vision software needed to operate the robotic arm 804 and cameras 126 and 128. The vision software for example can be used to determine if a light in the UUT 118 is operational by taking a picture with the camera 128 and sending the picture to the vision compare software that is executed by controller 802. The vision compare software compares the picture that has been taken to a pre-programmed picture and determines if the light is on or off during testing. Controller 802 is also coupled to input/output devices such as monitor 108, a keyboard, cameras 128 and 126, a microphone, a scanner for scanning bar code or other information from the UUT 806, etc. A database 812 is coupled to the controller 802 and is used to store the information collected from the test and inspection of the UUT. The database 812 can be located either locally or remotely. Database 812 can also have stored therein pictures of UUT's 806 which have been manufactured correctly so the portable test and inspection system 100 can take images with cameras 126 and 128 and compare those images to those stored in database 812 for correctly built UUT's 806. If the image information do not match, for example a control switch is missing from the UUT 806, a warning message can be provided to the test operator using monitor 108 and the problem noted in the test report which can be stored in the database 812 and/or controller 802. Such as warning message can cause the UUT 806 to fail the test/inspection. Test system 100 in one embodiment stores in database 812 for each UUT 806 that is tested operator/user information, UUT serial number, UUT part number, pass/fail information for each test conducted, a picture file name for each picture/image associated with the particular UUT test. Controller 802 also provides control to any necessary power supply and test and switching equipment 808, as well as the keyboard, scanner, cameras, microphone, etc. 810 used to test and inspect the UUT 806.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A robotically assisted test and inspection system, comprising:
a test cart including first and second shelves, the first shelf for receiving a unit to be tested, the first shelf having one or more apertures;
a robotic arm located on the second shelf; and
a controller for controlling the robotic arm, the robotic arm activating one or more controls located on the unit to be tested that protrude through the one or more apertures.

2. A robotically assisted test and inspection system as defined in claim 1, further comprising a plurality of wheels coupled to the test cart.

3. A robotically assisted test and inspection system as defined in claim 1 further comprising:
a vision inspection camera located on the second shelf for visually inspecting a first side of the unit to be tested.

4. A robotically assisted test and inspection system as defined in claim 3, further comprising:
a second vision inspection camera mounted so that it can visually inspect a second side of the unit to be tested.

5. A robotically assisted test and inspection system as defined in claim 1, further comprising:
a support member coupled to the test cart for supporting a display monitor.

6. A robotically assisted test and inspection system, comprising:
a portable test cart including first and second shelves and one or more wheels;
a unit-under-test (UUT) including first and second sides;
a robotic arm located on the second shelf;
the portable test cart's first shelf for receiving the UUT, the first shelf having one or more apertures which expose a portion of the first side of the UUT to the robotic arm when the UUT is placed on the first shelf;
a camera support coupled to the first shelf;
a camera coupled to the camera support, the camera positioned so that it can take images of the second side of the UUT when the UUT is placed on the first shelf; and
a controller for controlling the robotic arm, the robotic arm activating one or more controls located on the UUT that are accessible through the one or more apertures of the first shelf.

7. A robotically assisted test and inspection system as defined in claim 6, further comprising:
a database coupled to the controller for storing information regarding the testing of the UUT.

8. A robotically assisted test and inspection system as defined in claim 7, wherein the camera takes an image of the second side of the UUT and the controller compares the image to an image stored in the database in order to determine if the UUT was manufactured properly.

9. A robotically assisted test and inspection system as defined in claim 6, further comprising:
a second camera located on the first shelf for taking an image of the first side of the UUT and the controller compares the image to an image stored in the database in order to determine if the UUT was manufactured properly.

10. A robotically assisted test and inspection system as defined in claim 9, further comprising:
wherein the UUT includes a light located on its first side; and
the second camera is used to determine if the light is operational by taking an image of the first side of the UUT when the controller causes the light to turn on during testing.

11. A robotically assisted test and inspection system as defined in claim 9, further comprising:
a microphone located on the first shelf, the microphone used for detecting sounds generated by the UUT in response to the controller causing the UUT to emit a sound during testing.

12. A robotically assisted test and inspection system as defined in claim 6, wherein the first shelf is removable from the portable test cart.

13. A robotically assisted test and inspection system as defined in claim 12, wherein an alternate first shelf can be attached to the portable test cart when the first shelf is removed.

14. A robotically assisted test and inspection system as defined in claim 13, wherein the alternate first shelf includes one or more apertures for accepting a different UUT having different dimensions.

15. A robotically assisted test and inspection system as defined in claim 14, further comprising:
a remote database coupled to the controller.
